(19) United States
(12) Patent Application Publication
(10) Pub. No.: US 2015/0266645 A1
(43) Pub. Date: Sep. 24, 2015

(54) RE-SEALABLE LID FILMS AND LABELS AND SYSTEMS AND METHODS FOR PRODUCING THE SAME

(71) Applicants: Brad BROWN, Dublin, CA (US); Brandon WARREN, Dublin, CA (US)

(72) Inventors: Brad BROWN, Dublin, CA (US); Brandon WARREN, Dublin, CA (US)

(73) Assignee: All American Label, Dublin, CA (US)

(21) Appl. No.: 14/222,256

(22) Filed: Mar. 21, 2014

(51) Int. Cl. B65D 75/58; B65D 65/40; B32B 3/10; B32B 38/04; B32B 37/18; B32B 37/12; B32B 37/00; B65D 65/14; B32B 27/32

(52) U.S. Cl. CPC B65D 75/5855; B65D 65/14; B65D 65/40; B32B 3/10; B32B 27/32; B32B 37/18; B32B 37/1292; B32B 37/0076; B32B 38/04; B65D 2575/586; B32B 2553/00; B32B 2519/00

(57) ABSTRACT

Re-sealable lid films and labels include cut patterns of different dimension in upper and lower material layers, whereby when an upper layer of material is peeled back, a bottom layer portion is exposed. Exposure of the bottom layer portion advantageously exposes printed indicia viewable on or through the bottom layer portion.

### BACKGROUND

The present disclosure is directed to labels and lid films, and more particularly to re-sealable labels and lid films, and methods of making the same.

There is a need in various industries for labels and packaging materials that include lids, labels and packages that can be opened or unsealed manually and re-closed and re-sealed, and which can be adapted to package any suitable products or attach to any suitable packaging or products. There is also a need for such lids, labels and packages to provide printed information, such as decorative or informational materials, e.g., logos, product information, advertisements, warnings, etc.

### BRIEF SUMMARY

The present disclosure is directed to re-sealable lid films and labels and more particularly to re-sealable lid films and labels having multiple layers of material, and methods of making the same. Re-sealable lid films and labels of the present disclosure advantageously include cut patterns of different dimension in upper and lower material layers, whereby when an upper layer of material is peeled back, a bottom layer portion is exposed. Exposure of the bottom layer portion advantageously exposes printed indicia viewable on or through the bottom layer portion.

According to an embodiment, a re-sealable lid film or label is provided. The lid film or label typically includes a first film layer having a first surface and a second surface, a second film layer having a first surface and a second surface, and a re-sealable adhesive layer disposed between the first film layer and the second film layer and adhering the second surfaces together in a releasable and re-sealable fashion. The lid also typically includes a first die cut pattern disposed in the first film layer and defining a first area of the first film layer, wherein the first die cut pattern extends through the first film layer but is not substantially present in the second film layer, and a second die cut pattern disposed in the second film layer and defining a second area of the second film layer, wherein the second die cut pattern extends through the second film layer but is not substantially present in the first film layer. Typically, the second area is larger than and encompasses the first area. When the second film layer is releasably removed or peeled back from the first film layer at the first die cut pattern, the portion of the first film layer defined by the first area remains adhered to the second film layer thereby exposing a portion of the re-sealable adhesive layer between the first die cut pattern and the second die cut pattern.

In certain aspects, the first surface of the second film layer includes mirror printed indicia, such that when viewed through the first film layer, the mirror printed indicia appear as regularly printed indicia. The second film layer is typically clear or substantially clear so as to allow viewing of the printed indicia through the film layer. In certain aspects, the mirror printed indicia overlay only the first area of the first film layer. In certain aspects, a layer of ink is disposed on the first surface of the second film, overlaying the mirror printed indicia, and wherein the layer of ink includes printed indicia thereon. The layer of ink typically prevents viewing of the mirror printed indicia on the first surface from above, but does not prevent viewing of the mirror printed indicia through the second film from below. The second film layer typically includes a thermoplastic material such as a polyolefin, a polyamide or a polyester material. An example of a particularly useful material for the second film layer is biaxially oriented polypropylene (BOPP). In certain aspects, the second die cut pattern defining the second area does not form a completely enclosed region, and the first die cut pattern defining the first area forms a completely enclosed region. In certain aspects, the second die cut pattern is substantially u-shaped.

According to another embodiment, a method is provided for forming a re-sealable lid film or label. The method typically includes providing a first film layer having a first surface and a second surface, providing a second film layer having a first surface and a second surface, and adhering the second surfaces together in a re-sealable fashion using a re-sealable adhesive disposed between the first film layer and the second film layer. The method also typically includes forming a first die cut pattern in the first film layer so as to define a first area of the first film layer, wherein the first die cut pattern extends through the first film layer but is not substantially present in the second film layer, and also forming a second die cut pattern in the second film layer so as to define a second area of the second film layer, wherein the second die cut pattern extends through the second film layer but is not substantially present in the first film layer. Typically, the second area is larger than and encompasses the first area. In certain aspects, the second die cut pattern defining the second area does not form a completely enclosed region, and the first die cut pattern defining the first area forms a completely enclosed region. In certain aspects, the second die cut pattern is substantially u-shaped.

According to another embodiment, a re-sealable lid film or label is provided. The lid film or label typically includes a first film layer having a first surface and a second surface, a second film layer having a first surface and a second surface, and a re-sealable adhesive layer disposed between the first film layer and the second film layer and adhering the second surfaces together in a releasable and re-sealable fashion. The lid also typically includes a first die cut pattern disposed in the first film layer and defining a first area of the first film layer, wherein the first die cut pattern extends through the first film layer but is not substantially present in the second film layer, and a second die cut pattern disposed in the second film layer and defining a second area of the second film layer, wherein the second die cut pattern extends through the second film layer but is not substantially present in the first film layer, wherein the second area is typically larger than and encompasses the first area. The lid also typically includes mirror printed indicia disposed on the first surface of the second film layer and overlaying the first area of the first film layer, a layer of ink overlaying the mirror printed indicia on the first surface of the second film layer, and printed indicia disposed on the layer of ink. When the second film layer is releasably removed or peeled back from the first film layer at the first die cut pattern, the portion of the first film layer defined by the first area remains adhered to the second film layer thereby exposing a portion of the re-sealable adhesive layer between the first die cut pattern and the second die cut pattern, and wherein when viewed through the first area of the first film layer, the mirror printed indicia appear as regularly printed indicia. In certain aspects, the second die cut pattern defining the second area does not form a completely enclosed region, and the first die cut pattern defining the first area forms a completely enclosed region. In certain aspects, the second die cut pattern is substantially u-shaped.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE SEVERAL VIEWS OF THE DRAWING(S)

FIG. 1a illustrates a top view of a re-sealable lid film according to an embodiment.

FIG. 1b illustrates a side view of the re-sealable lid film of FIG. 1a.

FIGS. 1c and 1d illustrate a side view of re-sealable lid films including additional layers according to an embodiment.

FIG. 2 illustrates an isometric view of a container including a lid film according to an embodiment.

FIG. 3 illustrates a side press view for implementing a process for forming a lid film according to an embodiment.

FIG. 4 illustrates an isometric side view of various layers and features of a lid film according to an embodiment.

FIG. 5 illustrates a process flow for forming a lid film according to an embodiment.

### DETAILED DESCRIPTION

The present disclosure is directed to re-sealable lid films and labels and more particularly to re-sealable lid films and labels having a multiple layer material, and methods of making the same. Lid films according to the present disclosure can advantageously be used as or formed into packages, lids that attach to or form packages or containers, or labels that attach to packages.

Re-sealable lids and labels of the present disclosure advantageously include cut patterns of different dimension in upper and lower material layers, whereby when an upper layer of material is peeled back, a bottom layer portion is exposed. Exposure of the bottom layer portion advantageously exposes printed indicia viewable on or through the bottom layer portion.

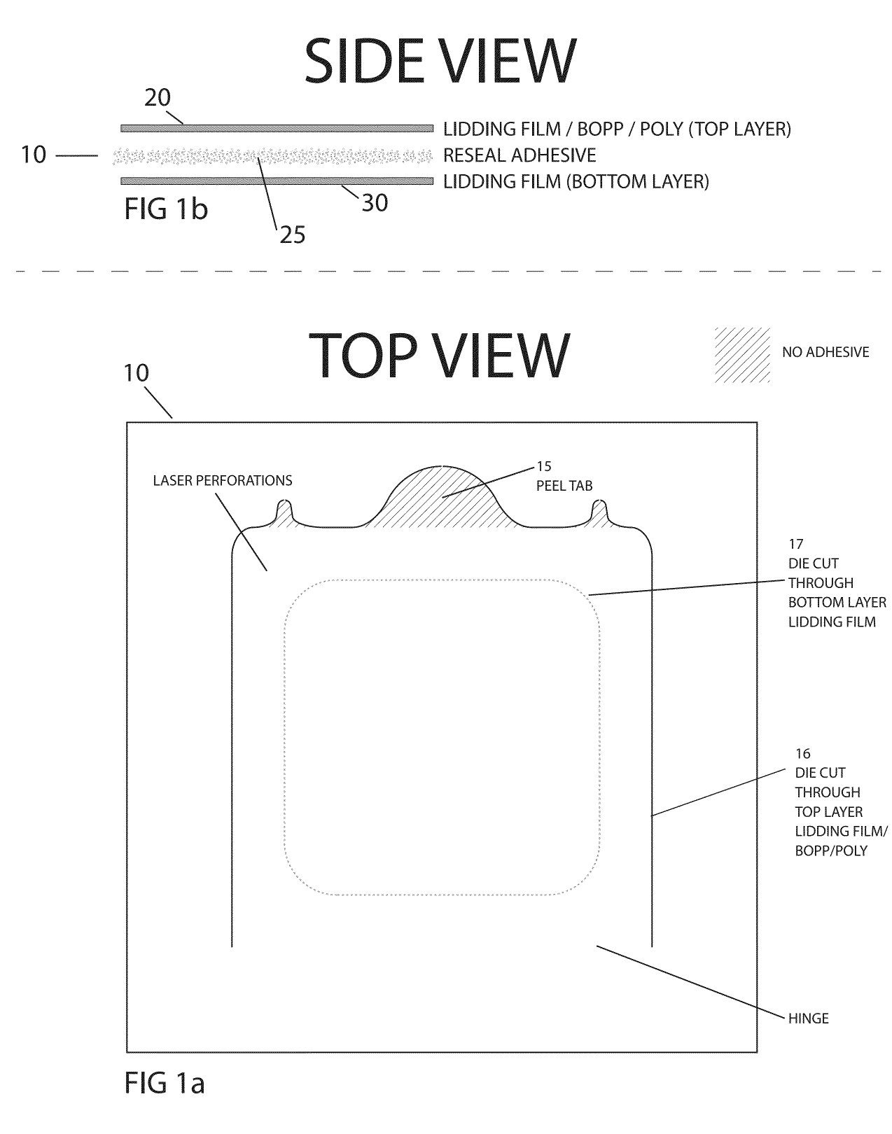

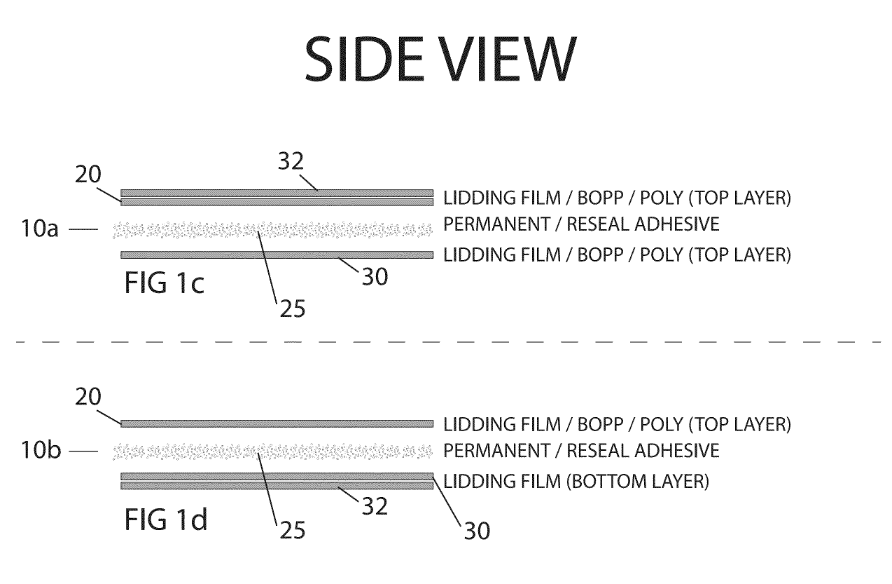

FIG. 1a illustrates a top view of a re-sealable lid film sheet 10 according to an embodiment. FIG. 1b illustrates a side view of the re-sealable lid film sheet 10 of FIG. 1a. Lid film sheet 10 includes a top layer 20, a bottom layer 30 and a reseal adhesive layer 25 disposed between the top and bottom layers. It should be appreciated that the thicknesses of the layers are not shown to scale and that the thicknesses are exaggerated for display purposes and may vary greatly. Adhesive layer 25 provides a releasable and re-sealable (e.g., re-usable) seal between the inner surface of top layer 20 and the inner surface of bottom layer 30. As used herein, when referring to layer 20 and layer 30, “inner surface” will refer to the surface or side of the layer exposed to or facing the adhesive layer and the other layer, and “outer surface” will refer to the surface facing away from the adhesive layer and the other layer. FIGS. 1c and 1d illustrate a side view of re-sealable lid film 10a and 10b, respectively, which include an additional layer of material 32 on top layer 20 or bottom layer 30 as shown. A permanent adhesive (or other adhesive) seals the layer 32 to the adjoining layer 20, 30 as shown. It should be appreciated that any number of layers may be present as desired for the particular application of the end product.

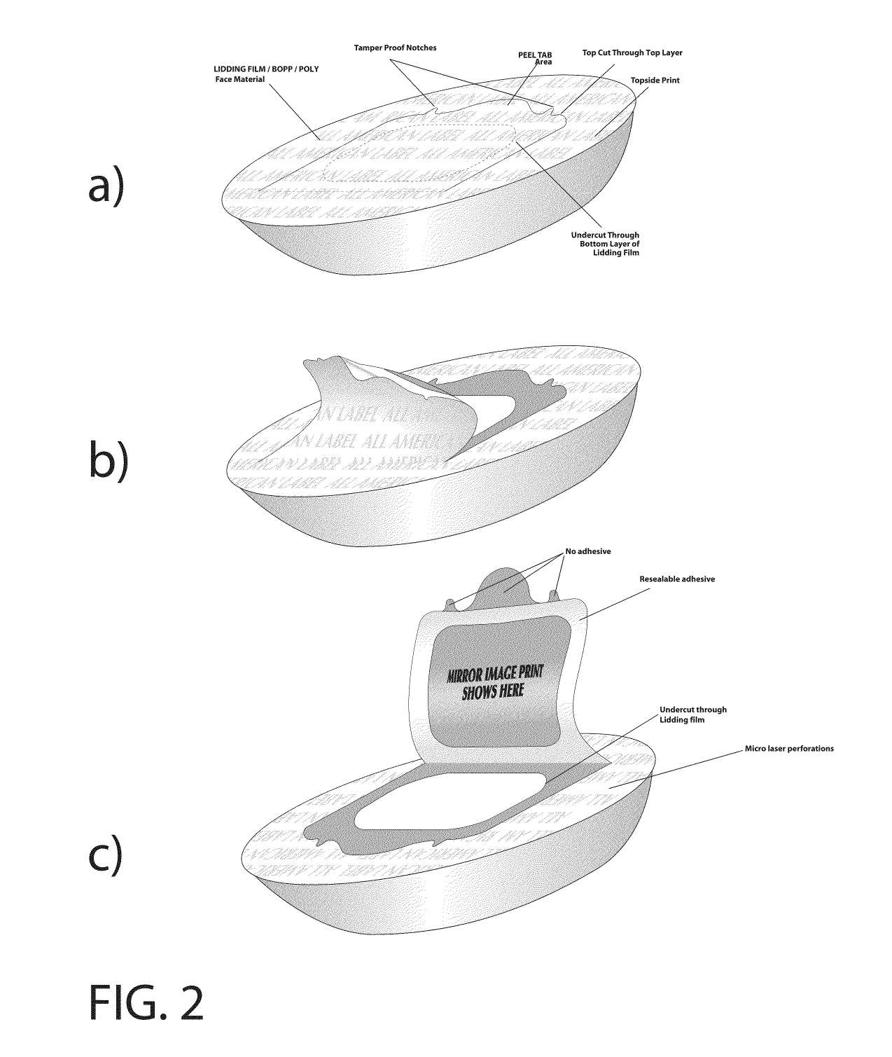

As will be described in more detail below, in one embodiment, lid film sheet 10 includes die cut patterns formed in the top layer 20 and in the bottom layer 30 in a fashion that allows a portion of the top layer to be peeled back from the bottom layer. The die cut pattern 16 in the top layer 20 includes a pattern of cuts that extends into or through the top layer 20, but which are not substantially present in the bottom layer 30. Similarly, the die cut pattern 17 in the bottom layer includes a pattern of cuts that extend into or through the bottom layer, but which are not substantially present in the top layer. As shown, for certain applications, the die cut pattern 16 in the top layer is substantially u-shaped, or of a shape that does not form a completely enclosed region, and the die cut pattern 17 in the bottom layer typically forms a completely enclosed region. In certain embodiments, the die cut pattern 17 in the bottom layer is smaller in area than the die cut pattern 16 in the top layer, and is also encompassed (completely, or almost completely) by the area defined by the die cut pattern 16 in the top layer as shown in FIG. 1. In this manner, when the top layer is peeled back, the portion of the bottom layer within the die cut pattern in the bottom layer stays adhered to the top layer and is able to completely separate from the remainder of the bottom layer, as shown in FIG. 2. Any printed indicia visible when viewing the bottom layer are thus viewable when the top portion is peeled back. The area and location of the die cut patterns in the top and bottom layers are typically sufficient to allow access to a user through the smaller die cut pattern. For example, when used as a lid film for a container, or when the layer 10 forms a container itself, the area and location of the die cut patterns in the top and bottom layers are sufficient to allow access and egress to product contained or stored within the container when the top layer is peeled back. At the same time, any printed indicia visible through the bottom layer portion still adhered to the top layer portion will be viewable when a user peels back the top layer. After being peeled back, a user may reclose the top layer; application of gentle pressure will re-seal the exposed adhesive on the top layer to the lower layer.

It should be appreciated that the die cut pattern 16 can be substantially u-shaped as shown, or can include any custom shape as desired. Also, the die cut pattern can include multiple die cut openings in the top of a “lid” product, e.g., to allow coverage over multiple compartments.

In certain embodiments, lid film sheet 10 includes one or more peel tabs 15 to facilitate a user gripping and peeling back the top layer. As shown in FIG. 1, peel tab region 15 is defined by an area between the top layer 20 and the bottom layer 30 that does not include reseal adhesive. It is noted that the region of no adhesive that defines the peel tab should not extend to or abut the die cut pattern 17 in the bottom layer 30 to allow for a complete re-seal of the top layer to the bottom layer. With such a peel tab, a user may more easily grab the top layer at the peel tab and initiate peeling back the top layer portion defined by the die cut in the top layer.

In certain embodiments, the thicknesses of the various material layers can vary widely. For example, the top layer material, e.g., BOPP, will typically have a thickness ranging from about 0.50 mils to about 2.0 mils. Similarly, the bottom layer material, e.g., lidding film will typically have a thickness ranging from about 0.50 mils to about 2.0 mils. Depending on the application, desired thicknesses for the final lid film product may range from about 1.50 mils to about 6.0 mils.

FIG. 2 illustrates an isometric view of a container including a lid film sheet 10 according to an embodiment. FIG. 2a shows the lid film sheet 10 attached to a container body. It should be appreciated that lid film sheet 10 may itself form a container, or be formed onto a container through a heat sealing process. FIG. 2b shows a view of a portion of the top layer of the lid film sheet 10 in a peeled back state. FIG. 2c shows another view of the top layer of the lid film sheet 10 in a peeled back state. As can be seen, any printed indicia associated with the bottom layer 30 are now visible to a viewer. In various embodiments, the printed indicia associated with the bottom layer 20 are printed on either the inner surface of the bottom layer, on the inner surface of the top layer, on the outer surface of the top layer or on the outer surface of the bottom layer, depending in part on the printing equipment configuration used to form the lid film sheet 10. In the example shown in FIG. 2, the printed indicia associated with the bottom layer 30 are mirror-image printed on the inner surface of the bottom layer (in which case at least the bottom layer is substantially clear), and/or on the outer surface of the top layer (in which case both the bottom layer and the top layer are substantially clear). In this manner, when viewed through the bottom layer, the viewer is able to interpret the printed indicia as if they were printed in a normal fashion. Alternatively, or in addition, printed indicia may be printed on the outer surface of the bottom layer itself, or on the inner surface of the top layer in a normal fashion such that when viewed through the bottom layer the printed indicia appear as if printed on the outer surface of the bottom layer.

In some embodiments, lid film sheet 10 includes a plurality of micro perforations in certain portions of the lid film sheet 10 or throughout lid film sheet 10. Such micro perforations may be formed using laser perforation techniques as are well known, or by other means as would be apparent to one skilled in the art, or the various layers making up lid film sheet 10 can be supplied with micro-perforations already in place. Micro perforations are useful in certain food storage applications requiring a lid film with desired breathability properties.

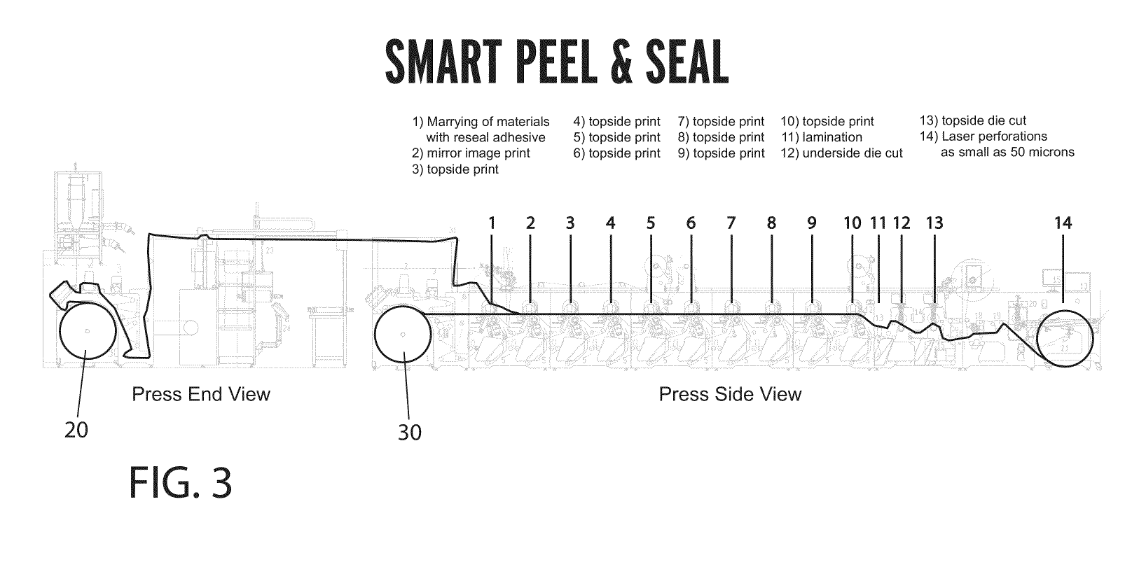

Lid film sheet 10 can include multiple cut patterns as described herein, e.g., forming an array of similar cut patterns. FIG. 3 illustrates a side view of a press or machine for implementing a process for forming a lid film according to an embodiment. In certain embodiments, the machine equipment used includes conventional flexographic processing and printing equipment as is well known. As shown on the left side of FIG. 3, a spool or roll of bottom layer material 30 and a spool or roll of top layer material 20 are both fed into the machine. The bottom layer material, in one embodiment, includes lidding film. The top layer material, in one embodiment, includes a thermoplastic material such as a polyolefin, a polyamide or a polyester. Specific examples include a polyolefin such as biaxially oriented polypropylene (BOPP), a polyamide such as biaxially oriented polyamide (BOPA), and a polyester such as biaxially oriented polyethylene terephthalate (BOPET). Other materials as known to one skilled in the art can be used. The top layer and the bottom layer materials may each include a mono-layer film or multi-layer film, and both top and bottom layers (or any layers in embodiments comprising more than two layers such as shown in FIG. 1c and FIG. 1d) can include the same material or different materials, such as lidding film, BOPP, etc as described herein.

The top and bottom layers are propagated through the machine and at point 1 the material layers are joined together, or married together, to form the basic structure of lid film sheet 10 as shown in FIG. 1b. Prior to being joined together, a reseal adhesive is applied to or deposited on either or both of lower layer material 30 and top layer material 20 and between the layers with a desired pattern. For example, where one or more peel tabs 15 are desired, the reseal adhesive pattern applied includes one or more regions of no adhesive that defines the peel tab regions in the final product. In one embodiment, the reseal adhesive layer includes a pressure sensitive adhesive material that adheres to most surfaces and bonds sufficiently firmly when slight pressure is applied. An example of a useful reseal adhesive includes a food-grade reseal adhesive as is well known. In certain embodiments both the top layer and bottom layers are corona treated prior to application of the reseal adhesive as is well known.

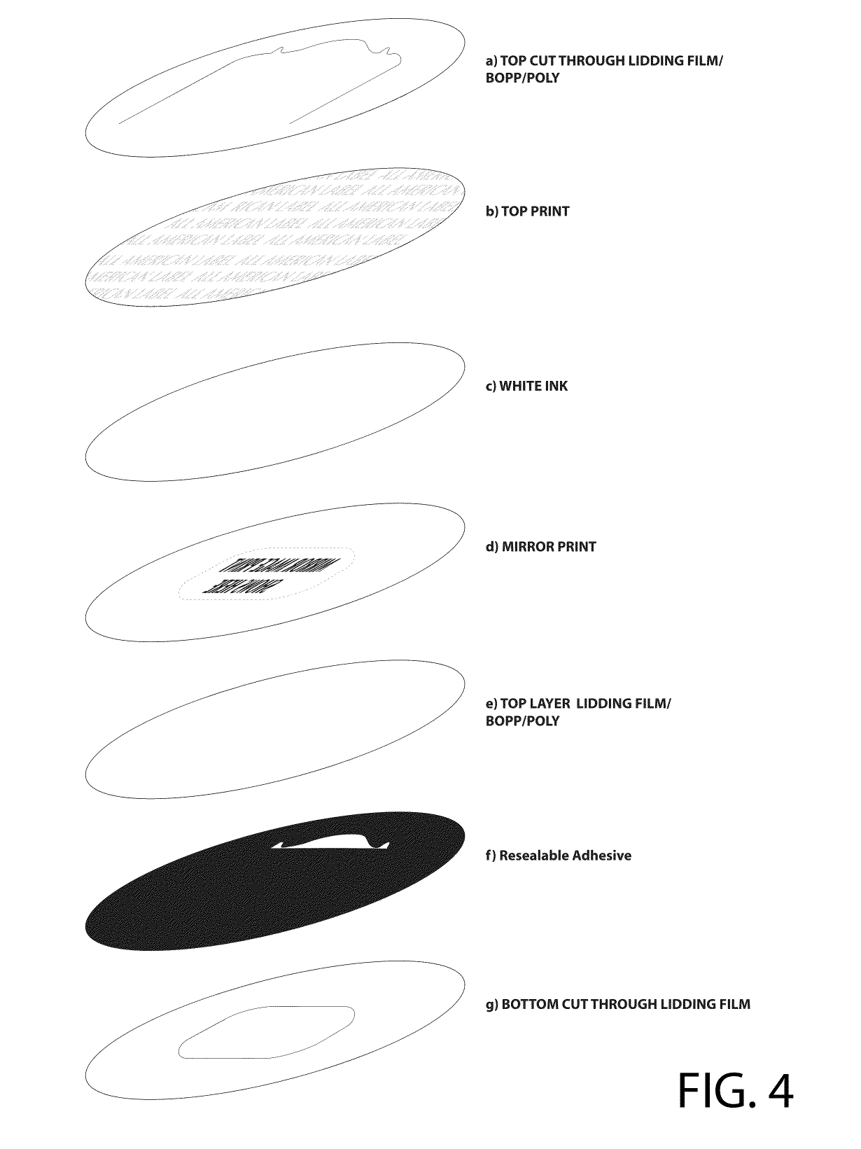

At point 2, the outer surface of the top layer is printed with a mirror image print (i.e., when viewed from above the printed indicia appear as a mirror image of normally printed indicia as shown in FIG. 4). At point 3, the outer surface of the top layer is printed over, e.g., with a white ink or other color ink, to cover the surface, or at least the portion of the outer surface having the mirror printed indicia. In this manner, the mirror printed indicia on the top layer are no longer viewable from above, yet remain viewable from below through the inner surface of the top layer. At points 4-10, additional printed indicia and/or ink layers may be deposited on the outer surface of the top layer to define the desired appearance of the final lid film product, and/or on the outer surface of the bottom layer. It should be appreciated that the printing steps associated with machine components 4-10 are optional and that the final product may only include the top layer covered in ink from component 3. It should also be appreciated that the mirror image printing at point 2 could be performed on the inner surface of the bottom layer (albeit prior to mating point 1). In certain aspects, the mirror image printing step 3 is also optional, for example, where it may not be desirable to include mirror printing viewable through the bottom layer.

At point 11, one or more additional layers of material are deposited on or applied to the outer surface of the top layer and/or the outer surface of the bottom layer (including applying adhesive material when needed). An additional material layer, in one embodiment, includes a lidding film, any clear polymer-based substrate film and/or a UV lamination material layer deposited or applied to the outer surface of the top layer. In certain embodiments, the additional layer(s) are optional depending on the desired application of the final lid film product. In certain aspects, adding additional layer(s) at step 11 is advantageous to vary the thickness of the final product to a desired size and/or protect the ink and printed indicia on the top layer. Another example of an additional layer includes a layer of BOPP and/or a lidding film layer as described above. At point 12, a desired underside die cut pattern is formed in the bottom layer, and at point 13 a desired die cut pattern is formed in the top layer. The die cut patterns can be formed by known means, including for example, any suitable means for cutting or scoring materials such as laser cutting. It should be appreciated that the order of components 12 and 13 could be switched, i.e., the top layer die cut pattern could be cut first and the bottom layer die pattern cut second. At point 14, optional micro perforations are formed in the lid film sheet, e.g., using laser perforation equipment and techniques, or other techniques as are well known. It should also be appreciated that die cutting can be performed prior to any of the printing points 2-10.

In some embodiments, the top layer and/or bottom layer materials are pre-printed with desired printed indicia or printed before mating step 1. In these embodiments, no additional printing steps may be needed. However, additional printing steps as disclosed above may be used with pre-printed material rolls to alter the appearance of the final product as desired. For example, the top layer roll may come pre-printed with mirror image print indicia on the outer surface—in this case, it may be desirable to cover the outer surface with a layer of ink as in step 3 and add printed indicia thereto. Alternatively, perhaps the top layer roll is pre-printed on the outer surface—in this case, it may be desirable to mirror image print the inner surface of the bottom layer in the region where the bottom layer die cut pattern will be formed and before the top and bottom layers are adhered together. One skilled in the art will appreciate the various printing combinations possible using pre-printed or non-printed material rolls.

FIG. 4 illustrates an isometric side view of various layers and features of a lid film according to an embodiment. FIG. 4 is not necessarily meant to convey that the layers shown are to be compressed together to form a film layer, but rather are meant to show or highlight features of individual layers or results of process steps. For example, FIG. 4a shows an example of a cut pattern in the top layer defining a region or portion of the top layer that may be peeled back. FIG. 4b shows an example of a print pattern (i.e., printed indicia) on the top layer (but without a cut pattern shown therein). FIG. 4c shows an example of a white ink layer as may be deposited or otherwise formed on top of the top layer, e.g., after formation of a mirror printed indicia, an example of which is shown in FIG. 4d, and before any printed indicia of FIG. 4b is applied. FIG. 4e shows an example of a top layer (e.g., lidding film, BOPP or poly-type layer). FIG. 4fe shows an example of a reseal adhesive pattern deposited or otherwise formed between the top and bottom layers. As shown, the pattern includes a region of no adhesive that defines a pull tab region for one or more pull tabs. FIG. 4gf shows an example of a cut pattern formed in the bottom layer.

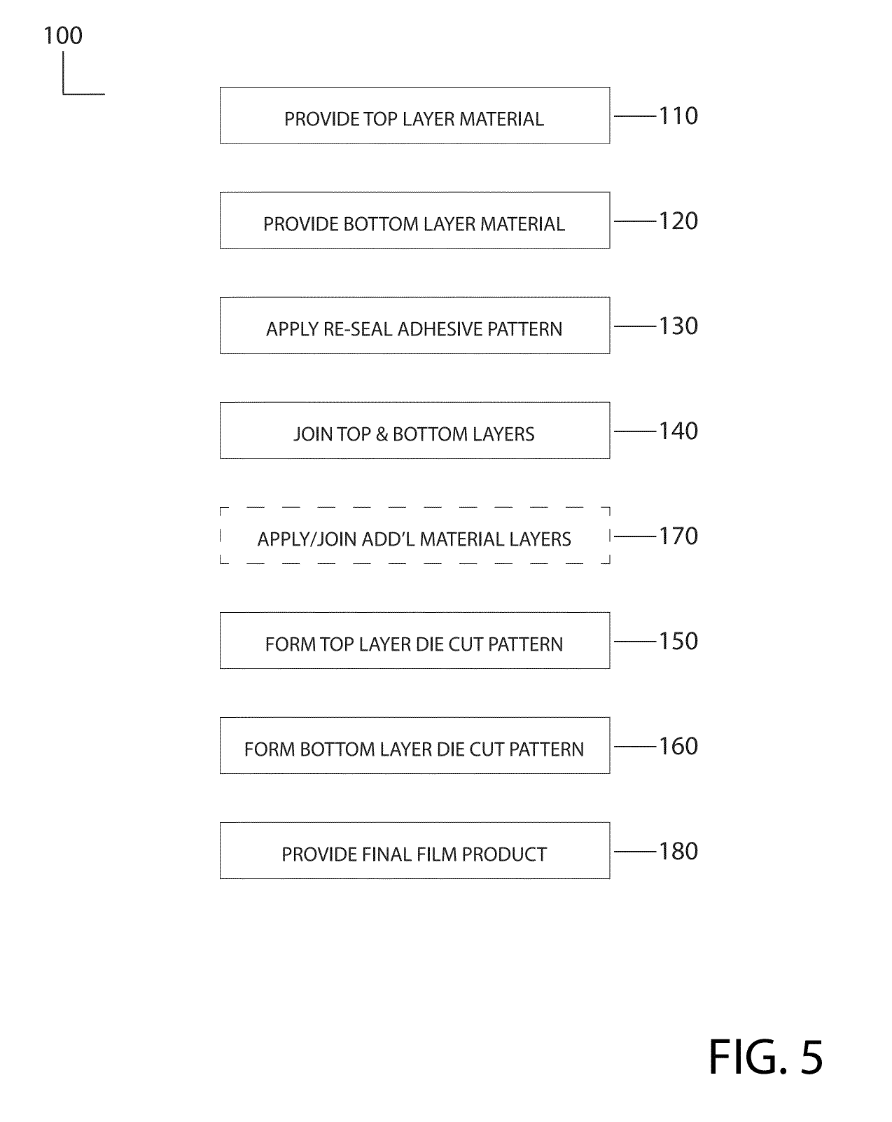

FIG. 5 illustrates a process flow 100 for forming a lid film sheet 10 according to an embodiment. At step 110 a roll of top film material is provided. For example, a roll of material is loaded onto a flexographic printing press or other processing machine. At step 120, a roll of bottom layer film material is provided. For example, a roll of material is loaded onto the same flexographic printing press or other processing machine. At step 130, the top and bottom material rolls are moved through the machine and the inner surface of either or both of the top and bottom layers are patterned with reseal adhesive. For example, a reseal adhesive material may be applied to or deposited on the bottom layer using patterning equipment as is well known to form the desired reseal adhesive pattern on the inner surface of the bottom layer material. An additional, optional step not shown in FIG. 5 includes corona treating the top and or bottom layers prior to step 130 to facilitate and optimize the bonding of the reseal adhesive.

At step 140, the top layer and bottom layer materials are joined together or adhered together. At step 150, a top layer die cut pattern is formed in the top layer material so as to define a first area in the top layer material. The top layer die cut pattern extends through the top layer but is not substantially present in the bottom layer. At step 160, a bottom layer die cut pattern is formed in the bottom layer material so as to define a second area in the bottom layer material. The bottom layer die cut pattern extends through the bottom layer but is not substantially present in the bottom layer. It should be appreciated that the order of steps 150 and 160 could be interchanged. In general, the second area formed by the die cut pattern in the top layer is larger than and encompasses the first area formed by the die cut pattern in the bottom layer. At optional step 170, one or more additional layers of material are applied to or joined with the outer surface of the top layer and/or the outer surface of the bottom layer. As shown, optional step 170 can occur before or after (or both before and after) either or both of die cut patterning steps 150 and 160. Additional, optional printing steps as discussed above are not shown in FIG. 5. Examples of such printing steps include mirror printing the outer surface of the top layer prior to or after mating step 150 and thereafter depositing a layer of ink on the (mirror printed) outer surface of the top layer, or mirror printing the inner surface of the bottom layer prior to mating step 150. At step 180, the final product is provided, e.g., as a roll of processed film lid material, for distribution, cutting, further processing, etc.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the embodiments (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All method or process steps described herein can be performed in any suitable order unless otherwise indicated herein or otherwise clearly contradicted by context. The use of any and all examples, or exemplary language (e.g., “such as”) provided herein, is intended merely to better illuminate the various embodiments and does not pose a limitation on the scope of the various embodiments unless otherwise claimed. No language in the specification should be construed as indicating any non-claimed element as essential to the practice of the various embodiments.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention. As used herein, the term “and/or” includes any and all combinations of one or more of the associated listed items.

It will be understood that when an element or layer is referred to as being “formed on” another element or layer, it can be directly or indirectly formed on the other element or layer.

That is, for example, intervening elements or layers may be present. In contrast, when an element or layer is referred to as being “directly formed on” another element, there are no intervening elements or layers present. Other words used to describe the relationship between elements or layers should be interpreted in a like fashion (e.g., “between” versus “directly between,” “adjacent” versus “directly adjacent,” etc.). Additionally, it should be understood that a layer can itself be made of a mono-layer of a single material, or multiple layers of the same or differing materials.

Spatially relative terms, such as “lower,” “upper”, “top,” “bottom” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device or lid film product in the figures is turned over, elements described as “lower” or “bottom” relative to other elements or features would then be oriented “upper” or “top” relative to the other elements or features. Thus, the exemplary term “lower” or “bottom” can encompass both an orientation of above and below. The device or product may be otherwise oriented (rotated 90 degrees or at other orientations) and the spatially relative descriptors used herein interpreted accordingly.

Exemplary embodiments are described herein, including the best mode known to the inventors. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, all modifications and equivalents of the subject matter recited in the claims appended hereto are included as permitted by applicable law. Moreover, any combination of the above-described elements in all possible variations thereof is encompassed unless otherwise indicated herein or otherwise clearly contradicted by context.

1. A re-sealable lid film, comprising:
a first film layer having a first surface and a second surface;
a second film layer having a first surface and a second surface;
a re-sealable adhesive layer disposed between the first film layer and the second film layer and adhering the second surfaces together in a releasable and re-sealable fashion;
a first die cut pattern disposed in the first film layer and defining a first area of the first film layer, wherein the first die cut pattern extends through the first film layer but is not substantially present in the second film layer; and
a second die cut pattern disposed in the second film layer and defining a second area of the second film layer, wherein the second die cut pattern extends through the second film layer but is not substantially present in the first film layer,
wherein the second area is larger than and encompasses the first area, whereby when the second film layer is releasably removed from the first film layer at the first die cut pattern, the portion of the first film layer defined by the first area remains adhered to the second film layer thereby exposing a portion of the re-sealable adhesive layer between the first die cut pattern and the second die cut pattern.

2. The re-sealable lid film of claim 1, wherein the first surface of the second film layer includes mirror printed indicia, such that when viewed through the first film layer, the mirror printed indicia appear as regularly printed indicia.

3. The re-sealable lid film of claim 2, wherein the mirror printed indicia overlay only the first area of the first film layer.

4. The re-sealable lid film of claim 2, further including a layer of ink disposed on the first surface of the second film, overlaying the mirror printed indicia, and wherein the layer of ink includes printed indicia thereon.

5. The re-sealable lid film of claim 1, wherein either the second surface of the first film layer or the first surface of the second film layer includes mirror printed indicia, such that when viewed through the first film layer, the mirror printed indicia appear as regularly printed indicia.

6. The re-sealable lid film of claim 1, wherein the first surface of the first film layer includes printed indicia.

7. The re-sealable lid film of claim 1, further including a layer of ink disposed on the first surface of the second film, wherein the layer of ink includes printed indicia thereon.

8. The re-sealable lid film of claim 1, wherein the second surface of the second film layer includes printed indicia.

9. The re-sealable lid film of claim 1, wherein the second film layer includes a thermoplastic material selected from the group consisting of a polyolefin, a polyamide and a polyester.

10. The re-sealable lid film of claim 1, wherein the second film layer includes biaxially oriented polypropylene (BOPP).

11. The re-sealable lid film of claim 1, wherein the first film layer includes a lidding film.

12. The re-scalable lid film of claim 1 wherein the lidding film comprises [list of lidding film materials??].

13. The re-sealable lid film of claim 1, further including a lamination layer overlaying the first surface of the second film.

14. The re-sealable lid film of claim 1, further including a plurality of micro-perforations extending through the first and second film layers.

15. A method of forming a re-sealable lid film, the method comprising:
providing a first film layer having a first surface and a second surface;
providing a second film layer having a first surface and a second surface;
adhering the second surfaces together in a re-sealable fashion using a re-sealable adhesive disposed between the first film layer and the second film layer;
forming a first die cut pattern in the first film layer so as to define a first area of the first film layer, wherein the first die cut pattern extends through the first film layer but is not substantially present in the second film layer;
forming a second die cut pattern in the second film layer so as to define a second area of the second film layer, wherein the second die cut pattern extends through the second film layer but is not substantially present in the first film layer,
wherein the second area is larger than and encompasses the first area.

16. The method of claim 15, further including applying mirror printed indicia on the first surface of the second film layer.

17. The method of claim 16, further including applying a layer of ink on the first surface of the second film, overlaying the mirror printed indicia.

18. The method of claim 17, further including applying printed indicia on the layer of ink.

19. The method of claim 17, wherein the layer of ink includes white ink.

20. The method of claim 15, further including applying mirror printed indicia on the second surface of the first film layer.

21. The method of claim 15, further including applying printed indicia on the first surface of the first film layer.

22. The method of claim 15, further including:
applying a layer of ink on the first surface of the second film; and
applying printed indicia on the layer of ink.

23. The method of claim 15, further including applying a lamination layer over the first surface of the second film.

24. A re-sealable lid film, comprising:
a first film layer having a first surface and a second surface;
a second film layer having a first surface and a second surface;
a re-sealable adhesive layer disposed between the first film layer and the second film layer and adhering the second surfaces together in a releasable and re-sealable fashion;
a first die cut pattern disposed in the first film layer and defining a first area of the first film layer, wherein the first die cut pattern extends through the first film layer but is not substantially present in the second film layer;
a second die cut pattern disposed in the second film layer and defining a second area of the second film layer, wherein the second die cut pattern extends through the second film layer but is not substantially present in the first film layer, wherein the second area is larger than and encompasses the first area,
mirror printed indicia disposed on the first surface of the second film layer and overlaying the first area of the first film layer;
a layer of ink overlaying the mirror printed indicia on the first surface of the second film layer;
and
printed indicia disposed on the layer of ink,
whereby when the second film layer is releasably removed from the first film layer at the first die cut pattern, the portion of the first film layer defined by the first area remains adhered to the second film layer thereby exposing a portion of the re-sealable adhesive layer between the first die cut pattern and the second die cut pattern, and wherein when viewed through the first area of the first film layer, the mirror printed indicia appear as regularly printed indicia.

25. The lid film of claim 24, wherein the second die cut pattern defining the second area does not form a completely enclosed region, and wherein the first die cut pattern defining the first area forms a completely enclosed region.

26. The lid film of claim 25, wherein the second die cut pattern is substantially u-shaped.

27. The method of claim 1, wherein the second die cut pattern defining the second area does not form a completely enclosed region, and wherein the first die cut pattern defining the first area forms a completely enclosed region.

28. The method of claim 27, wherein the second die cut pattern is substantially u-shaped.

29. The method of claim 15, wherein the second die cut pattern defining the second area does not form a completely enclosed region, and wherein the first die cut pattern defining the first area forms a completely enclosed region.

30. The method of claim 29, wherein the second die cut pattern is substantially u-shaped.
